(19) United States
(12) Patent Application Publication
(10) Pub. No.: US 2007/0286100 A1
(43) Pub. Date: Dec. 13, 2007

(54) Local discovery of mobile network services

(76) Inventors: Mika Juhani Saaranen, Pirkkala (FI); Jari Mutikainen, Helsinki (FI); Jose Costa-Requena, Helsinki (FI); Igor Danilo Curcio, Tampere (FI); Juha Hietasarka, Suinula (FI); Holger Hussmann, Tampere (FI); Ulla Konkarikoski, Tampere (FI); Jari A. Mononen, Ruutana (FI); Petri Nykanen, Nokia (FI); Seppo Pohja, Tampere (FI); Jyrki Valli, Tampere (FI)

Correspondence Address: Hollingsworth & Funk, LLC;Suite 125, 8009 34th Avenue South, Minneapolis, MN, 55425, US

(21) Appl. No.: 11/450,966

(22) Filed: Jun. 9, 2006

(51) Int. Cl. H04L 12/16

(52) U.S. Cl. 370/260

(57) ABSTRACT

Local discovery of mobile network services involves coupling a communications device to a local network segment of a mobile data network. An announcement is sent from the communication device and/or a network entity (such as a network proxy) describing a service available via the respective devices. The announcement is receivable by any device on the local network segment. A request is received at the device for a detailed description of the service information in response to the announcement. A description of the service is sent from the communications device to the originator of the request in response to the request, and the service is established between the originator and the communication device and/or network entity in response to the sending of the description of the service

### FIELD OF THE INVENTION

This invention relates in general to mobile communications, and more particularly to providing mobile services via local networks.

### BACKGROUND OF THE INVENTION

Mobile and landline/wireline computing devices have, in recent years, become a valuable tool in day-to-day communications. Desktop computers, workstations, and other wireline computers currently allow users to communicate via e-mail, video conferencing, and instant messaging (IM) to name a few communication applications. Mobile devices, such as mobile telephones, handheld computers, personal digital assistants (PDAs), etc. also assist in day-to-day communication. Mobile/wireless telephones have conventionally served as voice communication devices, but through technological advancements have recently proved to be effective devices for communicating data, graphics, etc. Wireless and landline technologies continue to merge into a more unified communication system, as user demand for seamless communications across different platforms increases.

Many communication applications allow for real-time or near real-time communication that falls outside of the traditional voice communication associated with wireline and wireless telephone communications. Chat sessions, instant messaging, Short Message Service (SMS), video conferencing, are but a few such communication vehicles. Many of these types of communications have been well-received by the communicating public, and are expected to become increasingly popular, particularly in view of the proliferation of wireless devices and continual technological breakthroughs.

An important protocol that allows rich services to be provided on mobile devices is the Session Initiation Protocol (SIP). SIP is a signalling protocol for multimedia real-time communication, such as audio, video and messaging. SIP is used in providing services such as Voice Over Internet Protocol (VoIP), Push To Talk (PTT) on mobile networks, etc. SIP is a standard for initiating, modifying, and terminating interactive user sessions. Typically, SIP sessions involves multimedia elements such as video, voice, instant messaging, push-to-talk voice communications, whiteboarding, online games, virtual reality, etc.

In order to implement such technologies, “presence” technology is used to determine the location, willingness to communicate, and other parameters relating to real-time or near real-time communications. Presence technology generally refers to applications and services that facilitate location and identification of one or more endpoints to such communication links. For example, if a user of a wireless, handheld device would like to initiate an IM session with another IM user, presence services may be used to present users' willingness to receive IM messages. Presence services are an integral part of third generation (3G) wireless networks, and are intended to be employed across a wide variety of communication devices.

Current presence service technology includes the concepts of presentities, presence servers, and watchers. Generally, a presentity can provide information as to its “presence” (e.g., location, willingness to communicate at a certain time or with certain users, etc.). This information can be collected and utilized by presence servers, that can notify authorized “watchers” who are interested in presence information that certain presence information is available. Similar with SIP protocols, presence services as currently implemented may require the services of a well-known location server or similar database in order to determined presence state of end-user device.

Fixed or well-known servers are typically found at fixed network locations. The “location” on the network generally refers to a network address and not necessarily a physical location. However, in most mobile services infrastructures, a service address will generally correspond to a particular geographical region where the servers are located. Thus communications between a mobile device and a presence server (or other fixed service asset) will require traversing a number of network segments that are potentially spread across a wide geographical region, and rely the operation of numerous intermediary elements (e.g., gateways and servers).

In typical mobile data communications infrastructures, the address of service entities must be preconfigured during device provisioning. Therefore, even if a device is able to connect to a local network segment, services such as SIP and presence may not be operative without such provisioning. There generally are no mechanisms for advertising and locating presence and related services on a local network segment.

On a local segment of a mobile network, it is not possible for SIP enabled devices to discover presence data or similar data without referencing a remotely located service element such as a SIP proxy and registrar in remote network This dependence on remote, centralized machines ultimately makes such services less reliable, slower, and less scalable. Accordingly, there is a need in the communications industry for a more efficient and convenient manner of exchanging data locally between networked devices in the mobile environment. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system, apparatus and method for local discovery of mobile network services. In one embodiment, a method involves coupling a communications device to a local network segment of a mobile data network. An announcement is sent from the communication device describing a service available via the communications device. The announcement is receivable by any device on the local network segment. A request is received at the communications device for a detailed description of the service information in response to the announcement. A description of the service is sent from the communications device to the network entity that originated the request in response to the request. The service is established between the communications device and the network entity in response to the sending of the description of the service.

In more particular embodiments, sending the announcement from the communication device involves sending the announcement from the communication device describing a session initiation service available via the communications device. The network entity may include a network proxy capable of registering the communications device for purposes of making the communications device accessible via the mobile data network. In such an arrangement, establishing the service between the communications device and the network proxy may involve exchanging Session Initiation Protocol messages between the communications device and the network proxy and/or registering, via the network proxy, the communications device in a globally accessible registrar.

In other, more particular embodiments, the service includes a presence service that indicates conditions under which a user of the communications device may be contacted. In one arrangement, sending the announcement from the communication device describing the service available via the communications device involves sending the announcement using a Simple Service Discovery Protocol message. In another arrangement, the sending of the announcement, the receiving of the request, and the sending of the description of the service are performed in conformance with Universal Plug and Play discovery protocols. Additionally, establishing the service between the communications device and the network entity may involve establishing a media session using the Session Initiation Protocol. In one configurations, establishing the media session between the communications device and the network entity using the Session Initiation Protocol comprises establishing the media session with a peer device located on the local network segment.

In another embodiment, a method involves coupling a network entity and a mobile communications device to a local network segment. The method involves performing, from at least one of the mobile communications device and network entity, the steps of: a) sending an announcement describing available services, wherein the announcement is receivable by any device on the local network segment; b) receiving a detailed description of the service information in response to the announcement; and c) sending a description of the service to the originator of the request in response to the request. The service is then established between the mobile terminal and the network entity in response to the sending of the description of the service.

In another embodiment, a method involves sending an announcement from a network proxy coupled to a local network segment. The announcement describes a registrar service available via the network proxy and is receivable by any device on the local network segment. A request is received at the network proxy for a detailed description of the registrar service information in response to the announcement. A description of the registrar service is sent from the network proxy to the network entity that originated the request in response to the request, and the network entity registers with the proxy in response to the sending of the description of the service.

In more particular embodiments, the network entity includes a mobile device, and registering the mobile device comprises registering the mobile device with a location service. Registering the mobile device with the location service may involve registering the mobile device using the Session Initiation Protocol and/or registering, via the network proxy, the mobile device in a globally accessible registrar.

In other, more particular embodiments, the registrar service includes a presence service that indicates conditions under which a user of the communications device may be contacted. In one arrangement, sending the announcement from the network proxy describing the service available via the communications device involves announcing the service using a Simple Service Discovery Protocol message. In another arrangement, sending of the announcement, the receiving of the request, and the sending of the description of the service are performed in conformance with Universal Plug and Play discovery protocols.

In another embodiment of the invention, an apparatus includes a network interface capable of communicating via a local network segment of a mobile data network. A processor is coupled to the one or more network interfaces. A memory is coupled to the processor. The memory includes a peer-to-peer connection module and a mobile services module. The peer-to-peer connection module has instructions that cause the processor to send an announcement describing a service of the mobile services module that is available via the network interface. The announcement is receivable by any device on the local network segment. The instructions further cause the processor to receive a request at the network interface for a detailed description of the service information in response to the announcement, and send, in response to the request, a description of the service to the network entity that originated the request. The mobile services module has instructions that causes the processor to establish the service with the network entity in response to the sending of the description of the service.

In more particular embodiments, the apparatus includes a proxy server, and the service of the mobile service module includes a registrar service capable of registering a communications device of the local network segment for purposes of making the communications device accessible via the mobile data network. In another configuration, the apparatus includes a mobile communications device. In such a configuration the service may include a presence service that indicates conditions under which a user of the mobile communications device may be contacted. In another arrangement, the peer-to-peer connection module is configured to send the announcement, receive the request, and send the description of the service in conformance with Universal Plug and Play discovery protocols.

In another embodiment, a computer-readable medium has instructions stored thereon which are executable by a communications device capable of being coupled to a local network segment of a mobile data network. The instructions are for performing steps that include sending an announcement from the communication device describing a service available via the communications device, wherein the announcement is receivable by any device on the local network segment; receiving a request at the communications device for a detailed description of the service information in response to the announcement; sending a description of the service to the network entity that originated the request in response to the request; and establishing the service between the communications device and the network entity in response to the sending of the description of the service.

In another embodiment, a system includes a local network segment of a mobile communications network. A mobile terminal is capable of being coupled to the local network segment, and a network entity is coupled to the local network segment. At least one of the mobile terminal and network entity are configured to: a) send an announcement describing available services, wherein the announcement is receivable by any device on the local network segment; b) receive a request for detailed description of the service information in response to the announcement; and c) send a description of the service to the originator of the request in response to the request. The mobile terminal and network entity are capable of establishing the service between the mobile terminal and the network entity in response to the sending of the description of the service.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIG. 2 is a block diagram illustrating a mobile apparatus according to embodiments of the invention;

FIGS. 3A and B are block diagrams illustrating announcement and use of mobile services using P2P protocols according to embodiments of the invention;

FIGS. 4A and 4B are block diagrams illustrating more particular examples of announcement and use of mobile services using P2P protocols according to embodiments of the invention;

FIGS. 5-9 are sequence diagrams illustrating particular examples of providing mobile services using P2P protocols according to embodiments of the invention;

FIG. 10 is a block diagram illustrating a network server according to embodiments of the invention;

FIG. 11 is a process for providing mobile services using P2P protocols according to embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to utilizing ad-hoc, peer-to-peer discovery mechanisms to enable direct communications between mobile devices on the same segment of a mobile data network in order to provide mobile services to those devices. These discovery mechanisms can free mobile devices from having to rely on centralized, infrastructure entities for such services as presence, news, and directory services. These discovery mechanisms can also enhance services currently available on the mobile networks. For example, out-of-band communications using the peer-to-peer protocols can be used for supplementing communications sessions that use established formats and protocols of the mobile communications network.

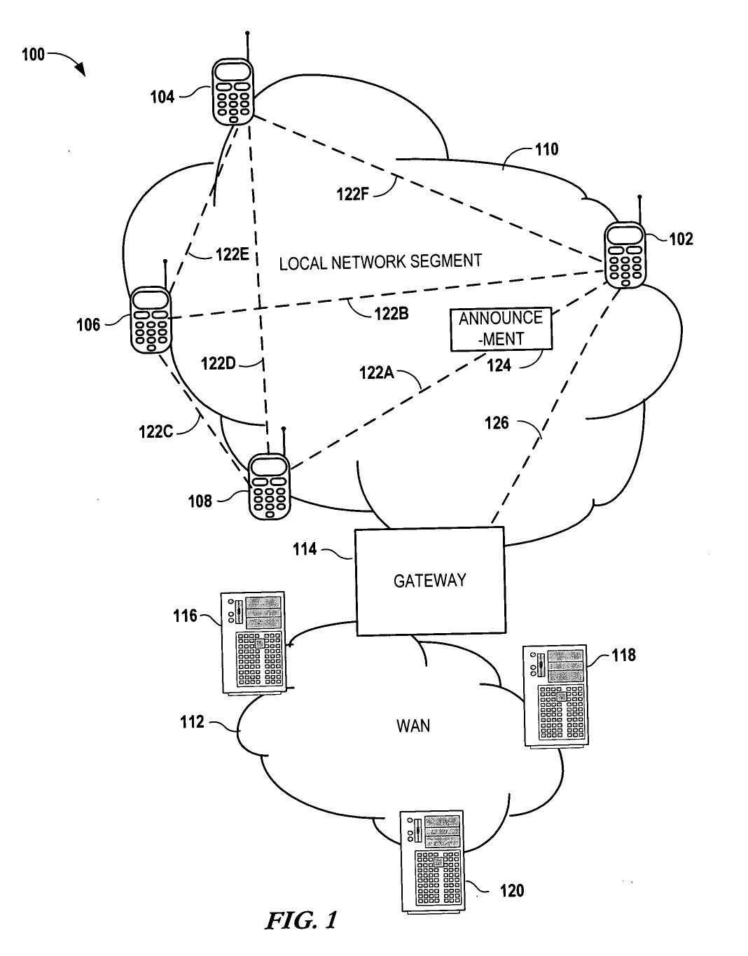

In reference now to FIG. 1, a system 100 according to an embodiment of the present invention is illustrated. A plurality of mobile devices 102, 104, 106, 108 are coupled to a local network segment 110. The local network segment 110 is coupled to a wide area network 112 via a gateway entity 114. The wide area network 112 may be a wireless provider network, geographically-dispersed private network, or a global area network such as the Internet. Generally, the wide area network 112 provides services, as represented by servers 116, 118, 120, that may be used by one or more of the mobile devices 102, 104, 106, 108.

As used herein, the term “local network segment” may include one or more logical or physical partitions of a communications network. For example, in Global System for Mobile Communications (GSM) using General Packet Radio Service (GPRS), a network segment may be defined by a particular Serving GPRS Support Node (SGSN). The SGSN provides conversion between radio network protocols and the Internet Protocol (IP) on the GPRS network. In wireless networks that conform to one of the 802.11 wireless local area network (WLAN) standards, a local segment may be defined by a particular service set identifier (SSID) used by one or more Access Points (AP). In yet another example, IP networks may define network segment by networks and subnetwork, as defined in the IP standards and by locally applied subnet masks. Devices that are coupled to any of these example local network segments 110 may utilize a gateway 114 or similar entity in order to access other parts of the larger network 112.

Typically, servers 116, 118, 120 reside at a fixed location on the network, therefore in order to access server 116, 118, 120, the mobile devices 102, 104, 106, 108 would need to use the gateway entity 114. However, this could be problematic in some situations. For example, where the gateway 114 is inoperative, the services 116, 118, 120 will be inaccessible. In other situations, there may be significant costs associated with using the gateway 114, particularly when compared to accessing equivalent services on the local network segment 110.

For some applications, a small number of globally accessible servers 116, 118, 120 that are located at a well-known location or address may be preferable. However, for other applications, all the needed data may be accessible via local or nearby elements of the network segment 110 from which the application operates. For example, where mobile devices 102, 104, 106, 108 on the same segment wish to intercommunicate, it may be unnecessary and inefficient to have data related to those communications remotely located on other segments of the wide area network 112. Therefore, in one embodiment of the invention, the mobile devices 102, 104, 106, 108 include ad-hoc, peer-to-peer (P2P) networking software that allows such data to be created, discovered, and applied to end devices on the local network segment 110. Such data may be later transferred to an element of the wide area network 112 when and if appropriate.

The P2P network in FIG. 1 is represented by data paths 122A-F. In this example, the paths 122A-F enable each mobile device 102, 104, 106, 108 to talk to any other device, such as might occur where broadcast or multicast networking is used. However, this level of interconnectivity is not always required in P2P networks. For example, technologies such as mesh networks, Gnutella, Freenet, BitTorrent, Internet Relay Chat (IRC), WASTE, etc., allow vast numbers of individual nodes to intercommunicate without relying on broadcasting or multicasting. Generally, these technologies rely on each node initiating connections with a small number of other nodes to form a “mesh.” Traffic is routed between nodes in the mesh in a typically ad-hoc fashion, e.g., without predefined or default routes.

There are many different peer-to-peer (P2P) paradigms and protocols used on the Internet and other networks. One commonly known P2P framework is Universal Plug and Play™ (UPnP). UPnP defines an architecture for pervasive, peer-to-peer networking between all types of consumer electronics, including intelligent appliances, wireless devices, and PCs of all form factors. UPnP technologies provide a way for disparate processing devices to exchange data via proximity or ad hoc networks. The UPnP framework is designed to bring easy-to-use, flexible, standards-based connectivity to ad-hoc or unmanaged networks whether in the home, in a small business, public spaces, or attached to the Internet. UPnP technologies provide a distributed, open networking architecture that leverages TCP/IP and the Web technologies to enable seamless proximity networking in addition to control and data transfer among networked devices.

The UPnP Device Architecture (UDA) is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices. The UPnP specification includes standards for service discovery. Various contributors publish UPnP device and service descriptions, thus creating a way to easily connect devices and simplifying the implementation of networks. The publishing and discovery of services and devices in UPnP is accomplished using the Simple Service Discovery Protocol (SSDP).

SSDP uses multicast messages allow network clients to discover network services without relying on a server or other authoritative network element. Devices advertise available services on the network by multicasting SSDP discovery messages, both when initially joining the network, and periodically thereafter. Devices can use discover network services by listening to these SSDP announcements, as well as by using SSDP search messages to query for services. The use of SSDP in advertising and discovery allows components to spontaneously interact, and do so without relying heavily on static configurations or authoritative servers.

Service discovery protocols are used to enable zero-configuration, discovery and control of networked devices. For instance, UPnP and Service Location Protocol (SLP) are examples of these kinds of protocols. These service discovery protocols are mainly intended for local discovery over a limited number of networked machines, such as a single IP subnet, although some protocols may be adapted to enable larger networks to be used. Many aspects of service discovery will be described herein in terms of UPnP and related protocols. However, those skilled in the art will appreciate the invention may be equally applicable to other ad-hoc, peer-to-peer network technologies.

Mobile device infrastructures usually rely on fixed entities (e.g., servers) to provide various services. However, the concept of service discovery embodied in UPnP can be extended to mobile devices 102, 104, 106, 108 operating on a local network segment 110 to enable those devices to use and provide services (e.g., acting as mobile servers) that were formerly provided using fixed network entities. The mobile devices 102, 104, 106, 108 may be able to establish paths 122A-F without reference to an authoritative server. For example, a device 102 may broadcast or multicast a short announcement 124 that indicates a willingness to engage in interactions on the network segment 110. This announcement 124 may be similar to an ssdp:alive message, which informs other devices 104, 106, 108 of the embedded devices and services available from the advertising device 102. Alternatively, the message 124 may be a broadcast/multicast of minimal data (e.g., an IP address/port) which may then be used to establish direct connections with the device 102. In the latter case, one or more other peers 102, 104, 106, 108 may form a mesh-type network using these announcements 124, and any further discovery data is then sent between peers using these dedicated connections 122A-F.

In another scenario, an infrastructure device, such as the gateway 114, coupled to the network segment 110 may provide certain minimal information that allows a connecting device 102 to discover other peers and services on the network segment 110. For example, as represented by path 126, the gateway 114 may inform the device 102 of a multicast channel of the local segment 110 to use for P2P interactions, such as sending and receiving of SSDP messages. Alternatively, the gateway 114 may be able to inform the device 102 of IP addresses of active peers 104, 106, 108 currently connected to the segment 110, such that the device 102 can establish its own connection with those peers 104, 106, 108 for purposes of service announcement and discovery.

After discovery of a P2P network on the network segment 110, devices 102, 104, 106, 108 can exchange data for any purpose, such as providing network services. Example services that are useful for mobile communications context are presence and news services (e.g., RSS, Internet chat). For example, devices 102, 104, 106, 108 on the segment can send out announcements that include information about the presence and news services supported by the devices 102, 104, 106, 108. The presence descriptions typically include protocol information for accessing the specific service (e.g., presence service IP address/port and/or URI). The same device can host several instances of the presence service, each service accessible using a different Uniform Resource Identifier (URI). For example, the same device 102 can host chat rooms, buddy lists, group presence service, etc., and thus a different URI could be associated with each of those applications/services. The presence subscription and notification can be implemented as known in the art, which includes using standard protocols such as the Session Initiation Protocol (SIP).

SIP is a signalling protocol for multimedia real-time communication, such as audio, video and messaging. SIP is used in providing services such as Voice Over Internet Protocol (VoIP), Push To Talk (PTT) on mobile networks, etc. SIP is a standard for initiating, modifying, and terminating interactive user sessions. Typically, SIP sessions involves multimedia elements such as video, voice, instant messaging, push-to-talk voice communications, whiteboarding, online games, virtual reality, etc. SIP peers may require the services of a location server or similar database in order to locate an end-user device, even though some negotiations of a SIP session may occur between the peers themselves.

The SIP framework was designed to provide functions analogous to those call processing functions and features present in the public switched telephone network (PSTN). As such, SIP provides features similar to those familiar to telephone users, such as dialing numbers and handling of various status tones (e.g. ringing, busy, dial-tone, etc.). SIP may also allow communications devices to use more advanced call processing features such as call-waiting, call-forwarding, caller identification, etc.

SIP works in concert with several other protocols and is only involved in the signaling portion of a communication session. SIP is generally used for setting up and tearing down voice or video calls. The media of SIP-established calls are often communicated over different protocols, such as the Real time Transport Protocol (RTP). SIP messages often encapsulate data conforming to the Session Description Protocol (SDP), which is used to describe and negotiate the media content of the session. For example, SDP can be used to describe codecs, data rates, TCP/UDP ports, and other data descriptive of the media session.

SIP provides means for SIP user agents to discover other endpoints and to negotiate the characteristics of the session media. SIP presence enables the user agents to advertise their communication capabilities and services to the other user agents in advance of the actual communication session. In the context of FIG. 1, presence subscription and notification can be implemented using SIP SUBSCRIBE and NOTIFY methods between peers 102, 104, 106, 108 that have discovered the existence of such services on the local segment 110 using a P2P protocol.

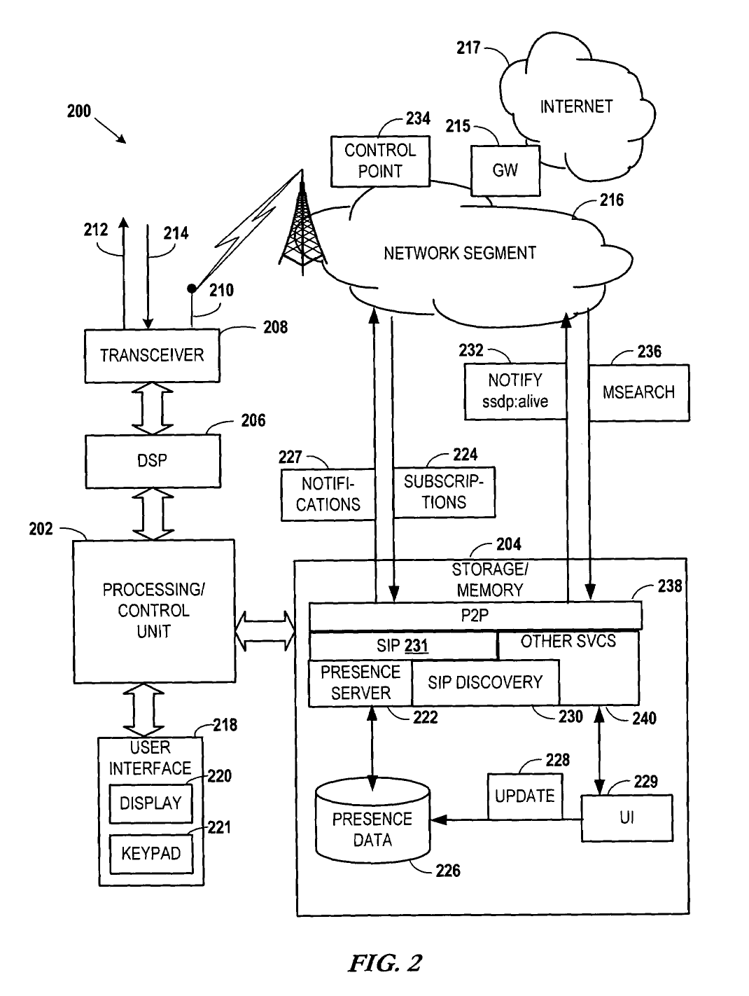

A user device that includes capabilities according to embodiments of the invention is shown as a mobile computing arrangement 200 in FIG. 2. The mobile computing arrangement 200 may be, for example, a mobile phone, a mobile communication device, a PDA, a digital mobile TV, a digital radio, a mobile audio/video device, a digital camera/camcorder, a PC, a laptop, a server, a storage device, a GPS device, a sensor, or any combination of the aforementioned. Those skilled in the art will appreciate that the exemplary mobile computing arrangement 200 is merely representative of general functions that may be associated with such mobile devices, and also that landline computing systems similarly include computing circuitry to perform such operations.

The processing unit 202 controls the basic functions of the arrangement 200. Those functions associated may be included as instructions stored in a program storage/memory 204. In one embodiment of the invention, the program modules associated with the storage/memory 204 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 200 via data signals, such as being downloaded electronically via one or more networks, such as the Internet and an intermediate wireless network(s).

The mobile computing arrangement 200 includes hardware and software components coupled to the processing/control unit 202 for performing network data exchanges. The mobile computing arrangement 200 may include multiple network interfaces for maintaining any combination of wired or wireless data connections. In particular, the illustrated mobile computing arrangement 200 includes wireless data transmission circuitry for performing network data exchanges.

This wireless circuitry includes a digital signal processor (DSP) 206 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 208, generally coupled to an antenna 210, transmits the outgoing radio signals 212 and receives the incoming radio signals 214 associated with the wireless device.

The incoming and outgoing radio signals 212, 214 to communicate with a network segment 216 of a mobile service provider. The network segment 216 may include any voice and data communications infrastructure known in the art, including CDMA, W-CDMA, GSM, EDGE, etc. The network segment 216 typically includes a fixed component such as a gateway 215 that allows devices on the network segment 216 to access traditional landline data infrastructures, including IP networks such as the Internet 217.

The processor 202 is also coupled to user-interface elements 218 associated with the mobile terminal 200. The user-interface 218 of the mobile terminal may include, for example, a display 220 such as a liquid crystal display. Other user-interface mechanisms may be included in the interface 220, such as keypads 221, speakers, microphones, voice commands, switches, touch pad/screen, graphical user interface using a pointing device, trackball, joystick, etc. These and other user-interface components are coupled to the processor 202 as is known in the art.

The program storage/memory 204 typically includes operating systems for carrying out functions and applications associated with functions on the mobile computing arrangement 200. The program storage 204 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 204 of the mobile computing arrangement 200 may also include software modules for performing functions according to embodiments of the present invention.

In particular, the program storage/memory 204 may include a presence server 222. The presence server 222 will receive subscriptions 224 from other users via the local network segment 216. The presence server 222 maintains a database of presence information 226 (e.g. XML documents) and can be enabled to send out notification messages 227 when the presence data 224 is updated 228. Here the presence update 228 is applied via a user interface 229, although other non-user-initiated events may also be used to change the presence data 226, such as time, terminal location, etc. In infrastructure based presence services, a central server maintains the user presence information, status, etc. Presence updates are applied at the presence server, and other users can subscribe to the presence server for receiving notification when the presence information of the user changes. In contrast, the example presence server 222 is part of a fully distributed presence service, enabling peer devices to act as presence or news servers. Other users will subscribe to those services hosted on each device. As such, the presence server 222 need not include an external protocol for presence data management (e.g., via an infrastructure-based presence server) since the data 226 is managed locally by the user. The presence server 222 typically includes or has access to the underlying protocol for subscription and notification (e.g. SIP 231).

In other arrangements, the device 200 may include a SIP discovery module 230. The SIP discovery module 230 may use UPnP protocol mechanisms and the like to locate other SIP-UPnP enabled devices on the local network segment 216. For example, the module 230 may send NOTIFY-ssdp:alive messages 232, making the device 200 visible as a SIP directory with a locally accessible address and allowing a UPnP control point 234 to start up SIP actions. The device 200 may also include a separate P2P protocol stack 238 to handle particulars of P2P communications (e.g., UPnP, SLP). The P2P and SIP stacks 238, 231 interoperate to form a P2P-SIP discovery device that discovers, for example, UPnP enabled SIP devices, and can be enabled to provide directory services for these devices, as well as for SIP-only devices. On the UPnP side 238, the device 200 can be configured to answer M-SEARCH messages 236 looking for certain kind of SIP devices, and/or provide lists of UPnP capabilites. It is also possible that SIP-only devices register directly with the SIP stack 231 through SIP actions, and UPnP-enabled devices do the same using UPnP actions with the P2P stack 238. UPnP can be used to provide a SIP service and device discovery for SIP devices in local IP networks. The benefit is that the SIP devices do not need to access a remote IP network, which may cause the user to incur extra charges, as well as decreasing service quality.

The device 200 may also include any other service modules that interact with any of the P2P and SIP modules 238, 231, as represented by service module 240. The service module 240 could provide, for example, news services such as RSS feeds, messaging such as Internet messaging, location services, etc. The service module 240 could also provide services such as buddy lists, group presence, podcasting, etc. Generally, these services may also interact with the user interface 229 for purposes such as content creation, service configuration, etc.

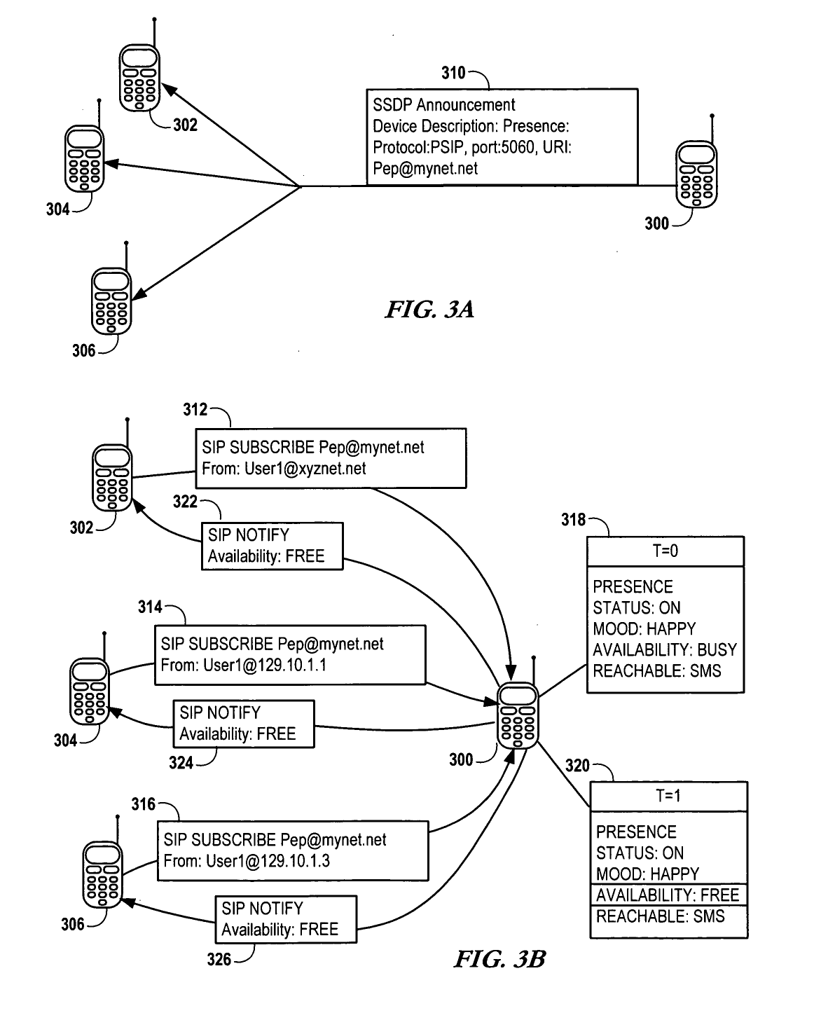

In reference now to FIGS. 3A-B, block diagrams illustrate the use of UPnP protocols to provide a presence service according to embodiments of the invention. The same reference numbers may be used to denote similar components in FIGS. 3A-B. In FIG. 3A, a terminal 300 is coupled via a local network segment (not shown) to terminals 302, 304, and 306. The terminal 300 sends an SSDP announcement 310 via any combination of broadcast, multicast, or unicast. The SSDP announcement 310 includes a description of a SIP presence service that is available from the terminal 300, and is received by terminals 302, 304, 306. In FIG. 3B, the terminals 302, 304, 306 have subscribed to the service via respective SIP SUBSCRIBE messages 312, 314, and 316 sent to the serving terminal 300. Thereafter, when the terminal 300 has a change of presence state, as indicated by the change in presence states 318, 320 between times t=0 and t=1, SIP NOTIFY messages 322, 324, and 326 are sent to terminals 302, 304, 306, respectively. The NOTIFY messages 322, 324, 326 allow terminals 302, 304, 306 to indicate the change of presence state relating to the user of terminal 300.

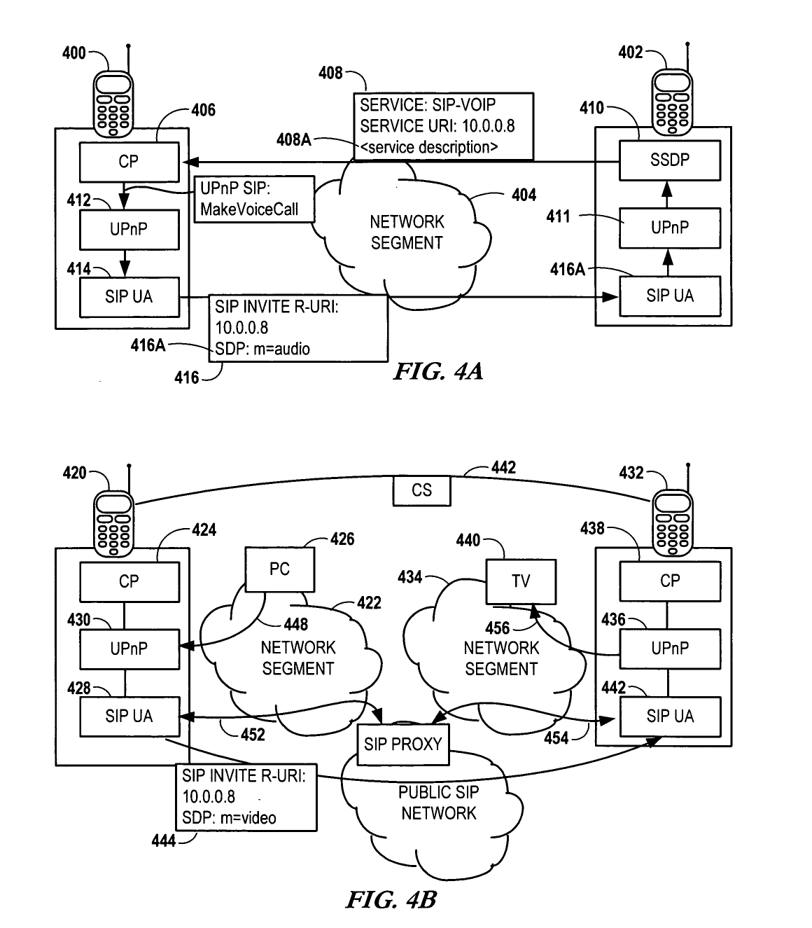

In reference now to FIG. 4A, an example of communications between terminals 400, 402 is illustrated according to embodiments of the present invention. In the arrangement of FIG. 4A, the terminals 400, 402 are SIP devices on the same local network segment 404, and are configured to find each other's IP addresses and respective SIP services available via those addresses. Based on this locally discovered data, the terminals are capable of engaging in a VoIP voice conversation via the local network segment 404. Initially, a control point module 406 of terminal 400 discovers terminal 402 based on an SSDP message 408 sent via an SSDP module 410 and UPnP module 411 of terminal 402. In particular, the SSDP message 408 includes a description 408A of a SIP service available from the terminal 402.

The first terminal 400 determines the SIP communication address and SIP VoIP service description 408A of terminal 402 based on receipt of the message 408. The VoIP service description 408A may contain SIP service capabilities using mechanisms currently known in the art, including advertising via SDP, SIP presence and/or using the SIP OPTIONS method. The service description 408A may indicate, for example, that terminal 402 is capable of engaging in full-duplex audio media and supports the SIP INVITE method. A UPnP module 412 in terminal 400 controls a SIP User Agent (UA) 414 for purposes of initiating a SIP VoIP call directed to the IP address of terminal 402. The SIP UA 414 sends an INVITE 416 to a SIP UA 418 of terminal 402. The SIP INVITE 416 includes an SDP description 416A of the audio media. From this point on, a regular SIP call is established between terminals 400, 402.

Although the example in FIG. 4A involves communications on a single network segment 404, in some situations, media communications using P2P discovery of SIP services may span two or more network segments. An example of a P2P-established, SIP session spanning multiple network segments according to embodiments of the invention is shown in the block diagram of FIG. 4B. Terminal 420 is coupled to a first network segment 422. The terminal 420 includes a control point 424 (e.g., a UPnP control point) capable of discovering and accessing other P2P services on the network segment 422. The terminal 420 has found other devices in the local network segment 422, in particular a personal computer (PC) 426. As a result of service discovery, the terminal 420 determines that the PC 426 can be used as a video media server, and the terminal 420 itself can render the video media.

Terminal 420 also includes a SIP UA 428 that can provide a SIP video sharing service. This SIP video sharing service can be advertised and rendered via a UPnP module 430. In a similar way, terminal 432 coupled to network segment 434 has a UPnP module 436 and control point 438. These UPnP components 436, 438 have discovered that a TV 440 that can provide a UPnP video rendering service. Terminal 432 also includes a SIP UA 442 that can provide SIP video sharing service. The terminals 420, 432 are also able to communicate through circuit-switched (CS) channels, such as via conventional cellular infrastructure (e.g., GSM, CDMA, etc.) and/or Public Switched Telephone Networks (PSTN). Therefore, the terminals 420, 432 may at some point initiate a CS call 442.

During the CS call 442, the user of terminal 420 may want to share a music video with the user of terminal 432. The video clip resides in user's PC 426. A user utilizes the terminal control point 424 to select the video clip from the PC 426 (e.g., using a UPnP Content Directory Service residing on the network) and starts the SIP video sharing service. The control point 424 in terminal 420 also controls the SIP UA 428 to send a SIP INVITE 444 to the SIP UA 442 in terminal 432. Once the user of terminal 432 accepts the SIP session, the control point 424 in terminal 420 controls the UPnP media renderer 430 in terminal 420 to send an RTSP PLAY signal to the UPnP media server in the PC 426. The PC 426 begins to stream the video clip to the UPnP video renderer 430 in terminal 420, as indicated by path 448

The UPnP video renderer 430 in terminal 420 further sends the video stream to the SIP UA 428 in terminal 420. The SIP UA 428 also sends the video stream towards the SIP UA 442 in terminal 432, as indicated by paths 452, 454. The user of terminal 432 receives the video stream to his mobile device 432. The user of terminal 432 may also want to see the video on a bigger screen, and thus selects the UPnP video render service from the TV 440. The control point module 438 in terminal 432 controls the UPnP media render in the TV 440 and sends RTSP PLAY to the UPnP media server 436 in terminal 432. The SIP UA 442 in terminal 432 sends the stream to UPnP media server 436, which sends the video to the TV 440, as indicated by path 456.

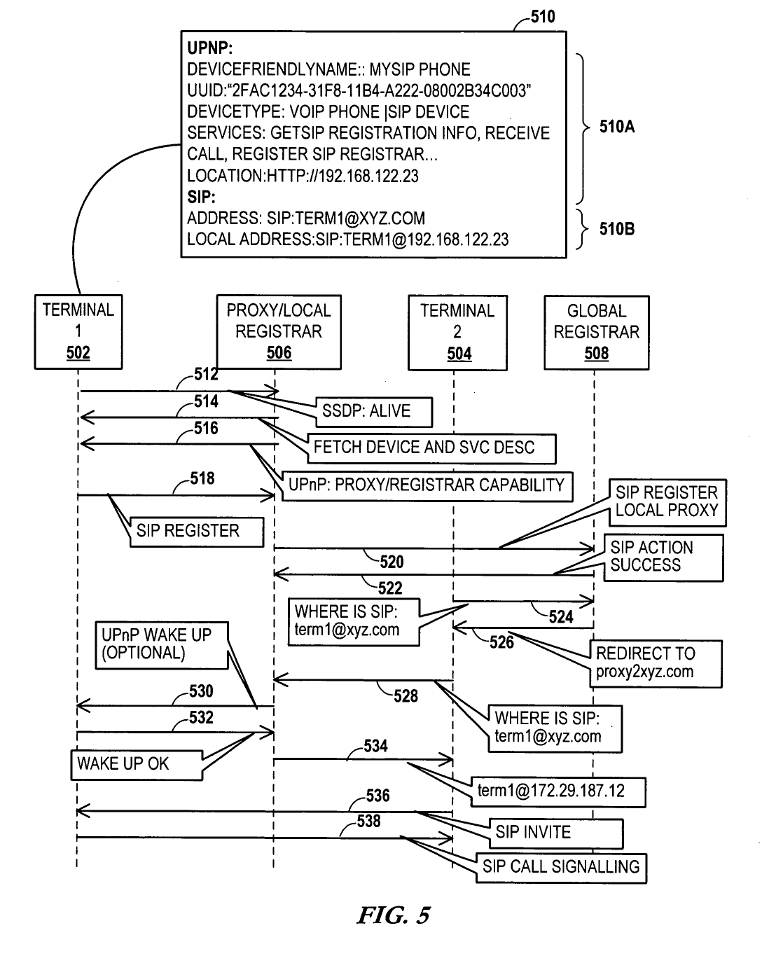

Further examples of providing services on mobile networks using P2P according to embodiments of the invention are shown in FIGS. 5-9, wherein the same reference characters are used to describe corresponding elements in FIGS. 5-9. Generally, FIGS. 5-9 detail ways that a first terminal 502 can advertise SIP services to a second terminal 504 that may be on the same or different network segment as the first terminal 502. A proxy/local registrar 506 is on the same network as at least the first terminal 502. The proxy/local registrar 506 may reside on a single system, or may be distributed between two or more distinct network entities. In some scenarios, a global registrar 508 may also be accessed. The global registrar 508 typically remotely located from the network segments where the terminals 502, 504 are located.

The first terminal 502 includes a SIP UA and UPnP module that can advertise and provide services over a local network segment. The first terminal 502 in these examples is associated with device data 510. The device data 510 has a UPnP portion 510A that is used to form UPnP service descriptions. The device data also has a SIP portion 510B that is used to engage in SIP transactions.

When first joining the network, the terminal 502 may obtain an IP address and default route via DHCP or other auto configuration protocol. The proxy/registrar 506 may act as a DHCP server, or these services may be provided by some other entity. In the illustrated example, it may be possible that the terminal 502 is not initially aware of any SIP proxies or registrars when the terminal 502 joins the network. Therefore, when the terminal 502 connects to the local network segment, it advertises its capabilities using an SSDP alive message 512. The SSDP alive message 512 may be broadcast, multicast, or unicast to any number of elements on the local segment. In response, the proxy/local registrar 506 fetches 514 the device and service description from the terminal 502. The proxy/local registrar 506 also uses UPnP protocol (or other P2P protocol) to describe its capabilities to the terminal 502 by way of a capabilities message 516 (e.g., an SSDP alive message). In response, the terminal 502 registers 518 with the proxy 506 using SIP.

The proxy/local registrar 506 then registers 520, 522 with the global registrar 508 on behalf of the terminal 502. Once the terminal 502 is registered with the proxy/local registrar 506, the terminal's SIP access data is updated in the global registrar 508. Thereafter, when the second terminal 504 wishes to contact the first terminal 502, a query 524 to the global registrar 508 results in a redirect 526 message indicating the address of the proxy 506 servicing the terminal 502. The second terminal 504 directs the query 528 to the proxy/local registrar 506. Because the first terminal 502 may be a low power, UPnP device, it may incorporate low power features defined for UPnP devices. In particular, low power features allow devices to go to sleep modes, yet still be available to provide services when requested via the network. Thus, the proxy/local registrar 506 may optionally send a UPnP wake-up 530, to which the terminal 502 responds 532 after waking up.

As a result of the first terminal 502 indicating availability 532 is that the proxy/local registrar 506 sends a message 534 containing a publicly routable IP address usable for accessing the first terminal 502. The IP address may be a globally routable address assigned to the terminal 502 itself. More commonly, however, the IP address and port will be assigned by a network entity (e.g., firewall, gateway, proxy) that acts as a Network Address Translator (NAT). The public address will be mapped to a private address by the NAT, and any connections at that address/port will be sent to the first terminal 502. As a result, the second terminal 504 may begin SIP signaling 536, 538 as known in the art in order to initiate a media session.

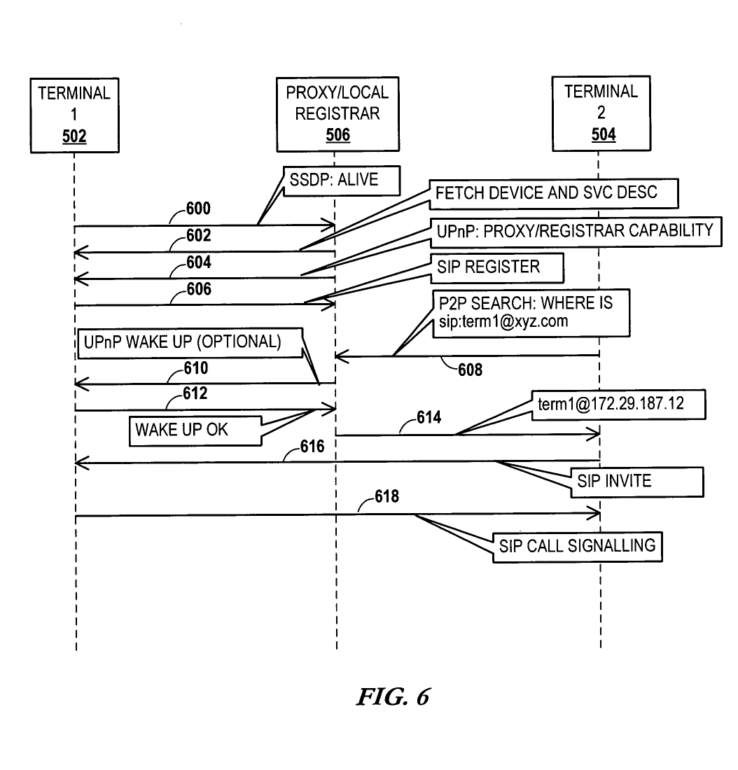

In reference now to FIG. 6, a different scenario according to embodiments of the invention is illustrated. As in the previous example, the terminal 502 advertises 600 using the appropriate P2P mechanism, and the proxy/local registrar 506 fetches 602 the service/device description, and uploads 604 its own service descriptors. Thereafter, the terminal 502 registers 606 with the proxy/local registrar 506. Unlike in previous scenarios, the second terminal 504 in this example does not attempt to locate the first terminal 502 using a global registrar. Instead, the second terminal 504 submits a query 608 using P2P mechanisms. For example, the query 608 may be a broadcast, multicast, or unicast via a local or remote network segment. Generally, broadcast traffic will be blocked from remote segments, and many providers will similarly block multicast traffic. Therefore, if the second terminal 504 is on a different network segment than the first terminal 502, other P2P mechanisms known in the art may be used. For example, a distributed or meshed P2P network may be established to pass along the location queries 608. Even if the query 608 is not multicast as defined in UPnP, the format and processing of the query may be substantially similar to UPnP or other service discovery standard. Upon receiving the query 608, the proxy/local registrar 506 recognizes that the queried URI corresponds to the first terminal 502, and optionally wakes up 610, 612 the first terminal 502. Once the first terminal 502 is recognized and awake, a routable IP address used to access the terminal 502 is sent in a query response 614, and the SIP session can be instantiated 616, 618 as is known in the art.

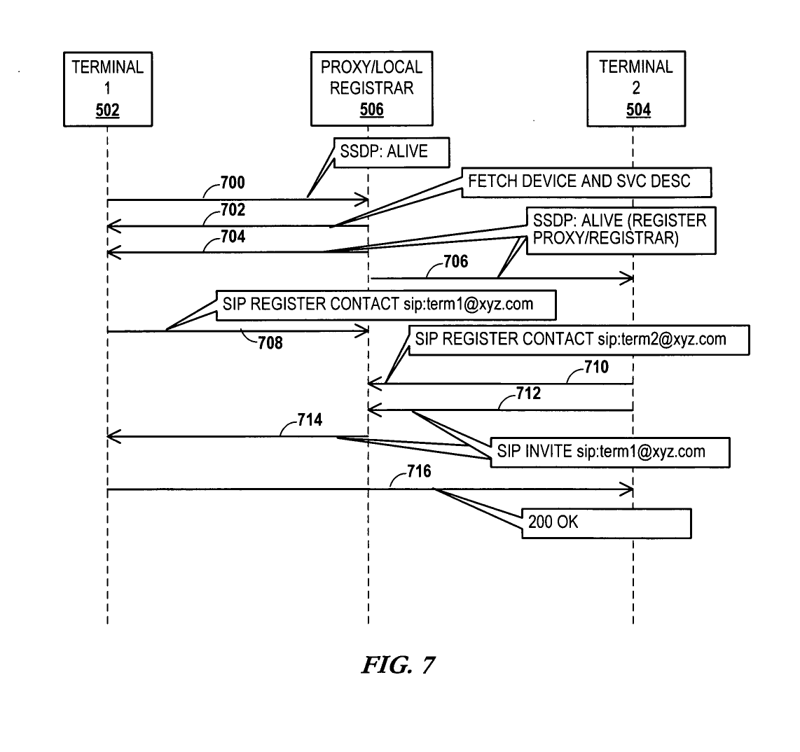

In the previous examples, the proxy/local registrar 506 responded to the SSDP broadcasts of the terminal 502 by sending service description data to the terminal 502 (e.g., message 604 in FIG. 6). However, the proxy/local registrar 506 can also broadcast its own services without waiting for a terminal to advertise. An example of such a scenario according to embodiments of the invention is shown in FIG. 7. The first terminal 502 may still advertise 700 its capabilities, and the proxy/local registrar 506 can fetch 702 a description of those capabilities. The proxy/local registrar 506 can also announces 704, 706 its capabilities to terminals 502, 504, which may be on the same or different network segments. In response, the terminals 502, 504 may download a full description of the capabilities (not shown), and register 708, 710 using SIP. Based on these registrations, the second terminal 504 can directly initiate 712, 714, 716 a session with the first terminal 502.

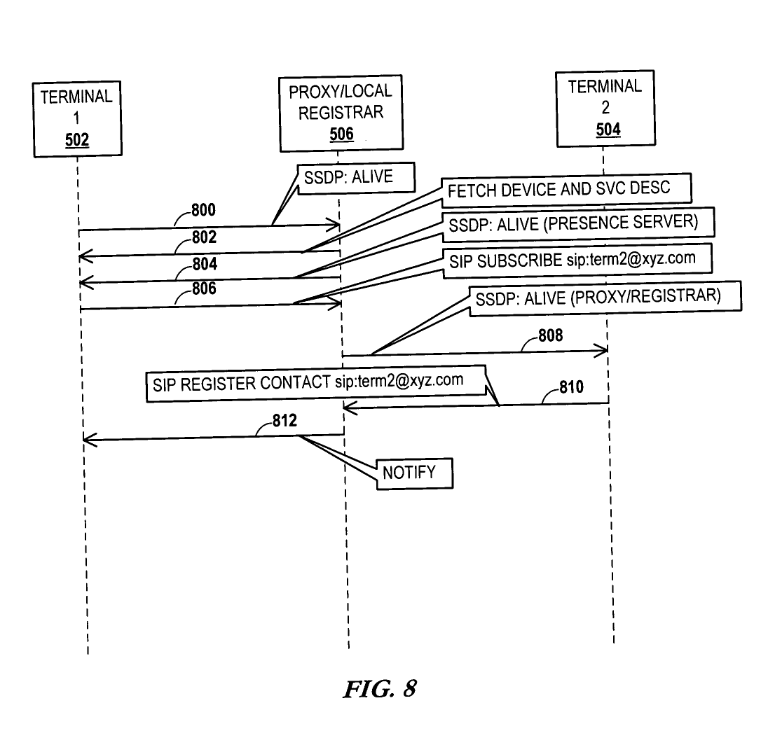

In reference now to FIG. 8, a scenario is illustrated where the proxy 506 acts as a presence server according to embodiments of the invention. As in the previous examples, the terminal 502 advertises 800 using the appropriate P2P mechanism, and the proxy/local registrar 506 fetches 802 the service/device description. The proxy/local registrar 506 also announces 804 its presence capabilities to terminal 502, which thereafter subscribes 806 to presence changes associated with the second terminal 504. Thereafter, the second terminal 504 registers 810 with the proxy/registrar 506 in response to a UPnP announcement 808 of the proxy/registration services. This registration 810 results in a change of presence related to the second terminal 504, and the first terminal 502 is duly notified 812.

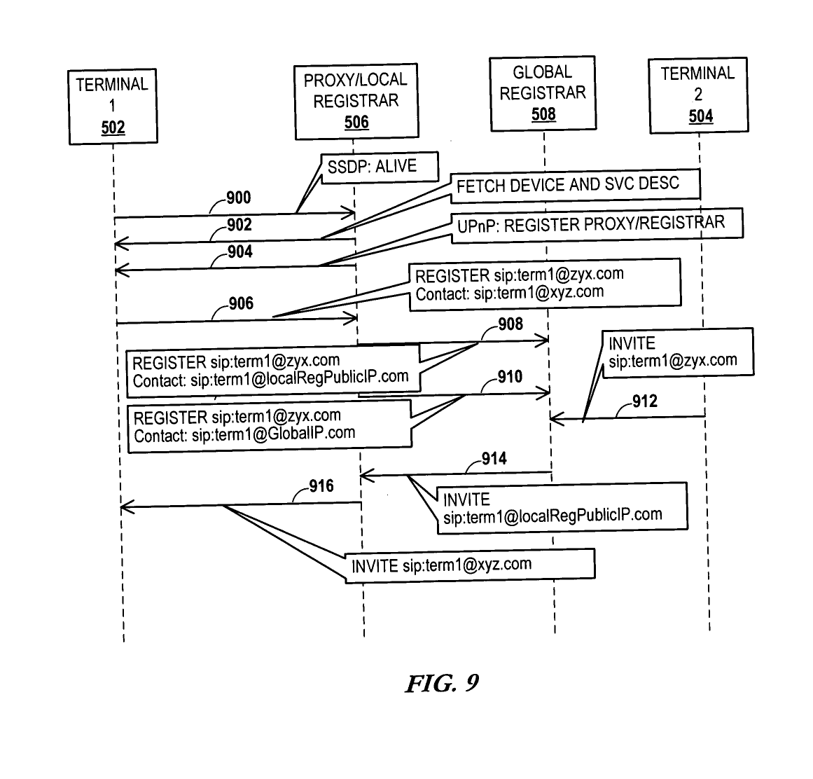

In reference now to FIG. 9, a scenario is illustrated where the proxy 508 updates local data to a global register according to embodiments of the invention. As in the previous examples, the terminal 502 advertises 900 using the appropriate P2P mechanism, and the proxy/local registrar 506 fetches 902 the service/device description. The proxy/local registrar 506 also announces 904 its presence capabilities to terminal 502. The terminal 502 registers 906 with the proxy/local registrar 506 to bind a new or different contact address with the terminal 502. In response, the proxy/local registrar 506 may send registration messages 908, 910 that bind one or more of a public address of the proxy/local registrar 506 (as in message 908) or a global IP as provided by a NAT (as in message 910). The second terminal 504 can thereafter invite 912 terminal 1 to engage in a SIP session, with the destination of the address being appropriately changed in subsequent forwarding 914, 916 of the invitation 912.

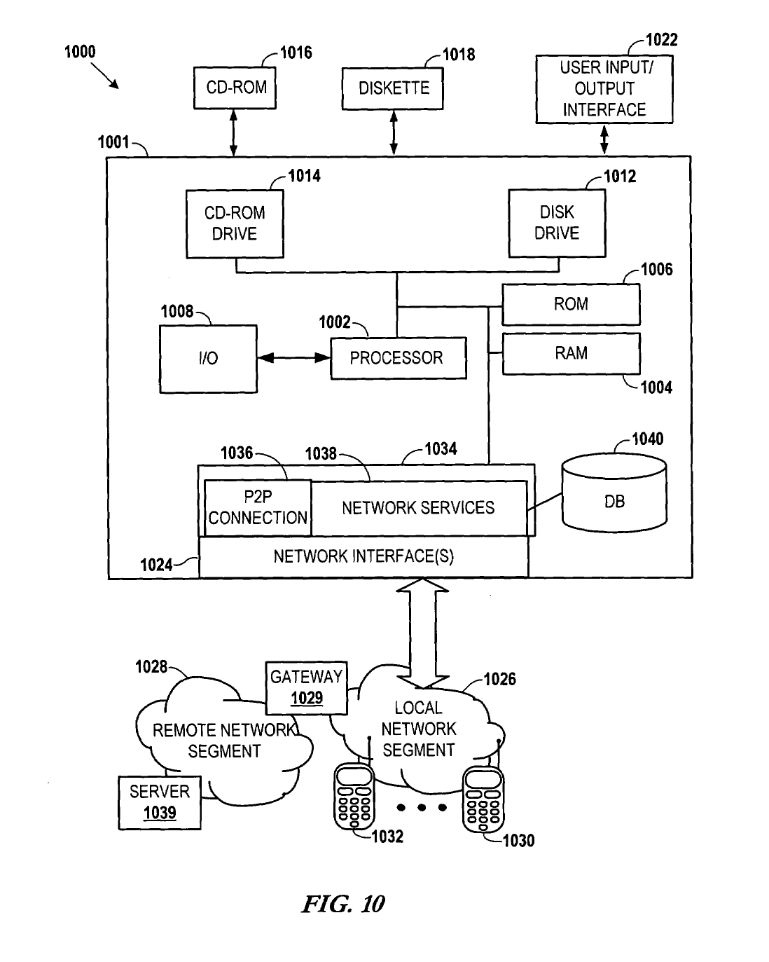

It will be appreciated that both mobile devices and fixed infrastructure devices (e.g., proxies, registrars, gateways, firewalls, etc.) may be configured to combine traditional mobile network services with P2P discovery and application protocols. A more detailed example of a network service element 1000 according to an embodiment of the invention is shown in the block diagram of FIG. 10. The service element 1000 includes a computing arrangement 1001. The computing arrangement 1001 may include custom or general-purpose electronic components. The computing arrangement 1001 includes a central processor (CPU) 1002 that may be coupled to random access memory (RAM) 1004 and/or read-only memory (ROM) 1006. The ROM 1006 may include various types of storage media, such as programmable ROM (PROM), erasable PROM (EPROM), etc. The processor 1002 may communicate with other internal and external components through input/output (I/O) circuitry 1008. The processor 1002 carries out a variety of functions as is known in the art, as dictated by software and/or firmware instructions.

The computing arrangement 1001 may include one or more data storage devices, including hard and floppy disk drives 1012, CD-ROM drives 1014, and other hardware capable of reading and/or storing information such as DVD, etc. In one embodiment, software for carrying out the operations in accordance with the present invention may be stored and distributed on a CD-ROM 1016, diskette 1018 or other form of media capable of portably storing information. These storage media may be inserted into, and read by, devices such as the CD-ROM drive 1014, the disk drive 1012, etc. The software may also be transmitted to computing arrangement 1001 via data signals, such as being downloaded electronically via a network, such as the Internet. The computing arrangement 1001 may be coupled to a user input/output interface 1022 for user interaction. The user input/output interface 1022 may include apparatus such as a mouse, keyboard, microphone, touch pad, touch screen, voice-recognition system, monitor, LED display, LCD display, etc.

The computing arrangement 1001 may be coupled to other computing devices via networks. In particular, the computing arrangement includes a network interface 1024, capable of interacting with one or more network segments, as represented by respective local and remote network segments 1026, 1028 that are coupled via one or more gateway devices 1029. The network interface 1024 may include a combination of hardware and software components, including media access circuitry, drivers, programs, and protocol modules. Ultimately, the computing arrangement 1001 may be configured to provide services to mobile terminals 1030, 1032 coupled to the local network segment, as well as communicating with entities of the remote network segment 1028 (e.g., server 1039).

The computing arrangement 1001 includes processor executable instructions 1034 for carrying out tasks of the computing arrangement 1001. These instructions 1034 may include a peer-to-peer connection module 1036 capable of announcing, discovering, describing, and utilizing peer-to-peer protocols on the local and/or remote network segments 1026, 1028. The peer-to-peer connection module 1036 may be capable of sending and receiving SSDP and other service related messages in conformance with the UPnP discovery protocols. The peer-to-peer connection module 1036 may also be able to utilize other P2P protocols independent of or in combination with UPnP and/or SLP. Such P2P protocols may include distributed search protocols (e.g., Gnutella, Freenet), distribute download protocols (e.g., Bittorrent) and/or distributed processing protocols (e.g., Berkeley Open Infrastructure for Network Computing, Alchemi).

The instructions 1034 also include a network services modules 1038. The network services module 1038 provides one or more services made available at least to mobile devices 1030, 1032 on the local network segment 1026. The services module 1038 typically includes a stack of processing portions to manage different protocols used in the mobile services, including SIP, SDP, HTTP, RTSP, RTP, present management, location services, directory services, buddy list management, etc. The services provided by the network services module 1038 are traditionally provided, at least in part, by a fixed, remote server, such as server 1039 on the remote network 1028. However, the network services module 1038 in this example interacts with the P2P connection module 1036 and other devices 1030, 1032 of the local network segment 1026, thus allowing such services to be provided without reliance on the central server entity 1039. As such, the network services module 1038 may interact with a database 1040 to store data related to mobile network devices 1030, 1032, such as presence state, address bindings, P2P device states, etc.

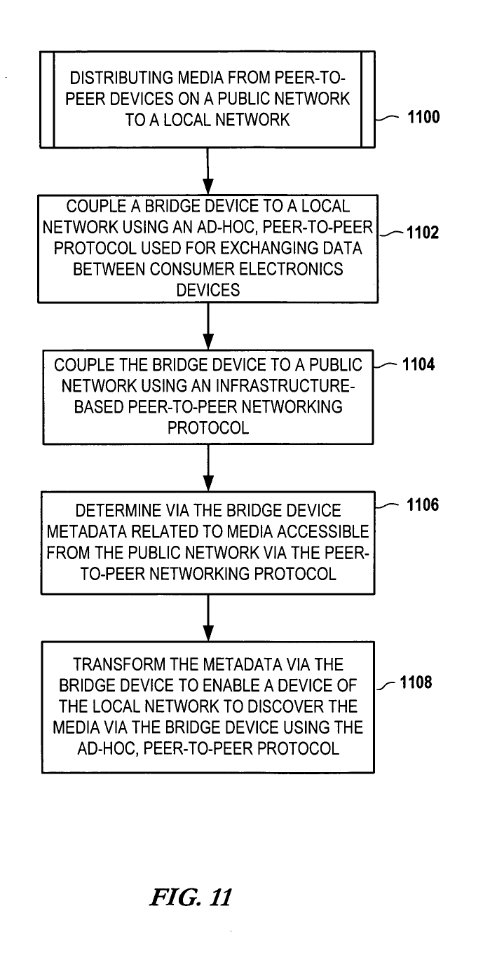

In reference now to FIG. 11, a flowchart illustrates a procedure 1100 for providing services via a communications device coupled to a local network segment of a mobile data network. An announcement is sent 1102 from the communication device describing a service available via the communications device. The announcement uses P2P mechanisms that allow the announcement to be received by any device on the local network segment. A request is received 1104 at the communications device for a detailed description of the service information in response to the announcement. The device sends 1106 a description of the service to the network entity that originated the request in response to the request. The service is then established 1108 between the communications device and the network entity in response to the sending of the service description of the service.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method, comprising:
coupling a communications device to a local network segment of a mobile data network;
sending an announcement from the communication device describing a service available via the communications device, wherein the announcement is receivable by any device on the local network segment;
receiving a request at the communications device for a detailed description of the service information in response to the announcement;
sending a description of the service from the communications device to the network entity that originated the request in response to the request; and
establishing the service between the communications device and the network entity in response to the sending of the description of the service.

2. The method of claim 1, wherein sending the announcement from the communication device describing the service available via the communications device comprises sending the announcement from the communication device describing a session initiation service available via the communications device.

3. The method of claim 1, wherein the network entity comprises a network proxy capable of registering the communications device for purposes of making the communications device accessible via the mobile data network.

4. The method of claim 3, wherein establishing the service between the communications device and the network proxy comprises exchanging Session Initiation Protocol messages between the communications device and the network proxy.

5. The method of claim 4, further comprising registering, via the network proxy, the communications device in a globally accessible registrar.

6. The method of claim 1, wherein the service comprises a presence service that indicates conditions under which a user of the communications device may be contacted.

7. The method of claim 1, wherein sending the announcement from the communication device describing the service available via the communications device comprises sending the announcement using a Simple Service Discovery Protocol message.

8. The method of claim 1, wherein the sending of the announcement, the receiving of the request, and the sending of the description of the service are performed in conformance with Universal Plug and Play discovery protocols.

9. The method of claim 8, wherein the establishing the service between the communications device and the network entity comprises establishing a media session using the Session Initiation Protocol.

10. The method of claim 9, wherein establishing the media session between the communications device and the network entity using the Session Initiation Protocol comprises establishing the media session with a peer device located on the local network segment.

11. A method, comprising
coupling a network entity and a mobile communications device to a local network segment;
from at least one of the mobile communications device and network entity, performing the steps of,
a) sending an announcement describing available services, wherein the announcement is receivable by any device on the local network segment;
b) receiving a detailed description of the service information in response to the announcement; and
c) sending a description of the service to the originator of the request in response to the request; and
establishing the service between the mobile terminal and the network entity in response to the sending of the description of the service.

12. A method comprising:
sending an announcement from a network proxy coupled to a local network segment, wherein the announcement describes a registrar service available via the network proxy and is receivable by any device on the local network segment;
receiving a request at the network proxy for a detailed description of the registrar service information in response to the announcement;
sending a description of the registrar service from the network proxy to the network entity that originated the request in response to the request; and
registering the network entity with the proxy in response to the sending of the description of the service.

13. The method of claim 12, wherein the network entity comprises a mobile device, and wherein registering the mobile device comprises registering the mobile device with a location service.

14. The method of claim 13, wherein registering the mobile device with the location service comprises registering the mobile device using the Session Initiation Protocol.

15. The method of claim 13, further comprising registering, via the network proxy, the mobile device in a globally accessible registrar.

16. The method of claim 12, wherein the registrar service comprises a presence service that indicates conditions under which a user of the communications device may be contacted.

17. The method of claim 12, wherein sending the announcement from the network proxy describing the service available via the communications device comprises announcing the service using a Simple Service Discovery Protocol message.

18. The method of claim 12, wherein the sending of the announcement, the receiving of the request, and the sending of the description of the service are performed in conformance with Universal Plug and Play discovery protocols.

19. An apparatus, comprising:
a network interface capable of communicating via a local network segment of a mobile data network;
a processor coupled to the one or more network interfaces; and
a memory coupled to the processor, the memory including a peer-to-peer connection module and a mobile services module, wherein the peer-to-peer connection module has instructions that causes the processor to,
send an announcement describing a service of the mobile services module that is available via the network interface, wherein the announcement is receivable by any device on the local network segment;
receive a request at the network interface for a detailed description of the service information in response to the announcement;
send, in response to the request, a description of the service to the network entity that originated the request; and
wherein the mobile services module has instructions that causes the processor to
establish the service with the network entity in response to the sending of the description of the service.

20. The apparatus of claim 19, wherein the apparatus comprises a proxy server, and wherein the service of the mobile service module includes a registrar service capable of registering a communications device of the local network segment for purposes of making the communications device accessible via the mobile data network.

21. The apparatus of claim 19, wherein the apparatus comprises a mobile communications device.

22. The apparatus of claim 21, wherein the service comprises a presence service that indicates conditions under which a user of the mobile communications device may be contacted.

23. The apparatus of claim 19, wherein the peer-to-peer connection module is configured to send the announcement, receive the request, and send the description of the service in conformance with Universal Plug and Play discovery protocols.

24. A computer-readable medium having instructions stored thereon which are executable by a communications device capable of being coupled to a local network segment of a mobile data network for performing steps comprising:
sending an announcement from the communication device describing a service available via the communications device, wherein the announcement is receivable by any device on the local network segment;
receiving a request at the communications device for a detailed description of the service information in response to the announcement;
sending a description of the service to the network entity that originated the request in response to the request; and
establishing the service between the communications device and the network entity in response to the sending of the description of the service.

25. A system comprising:
a local network segment of a mobile communications network;
a mobile terminal capable of being coupled to the local network segment;
a network entity coupled to the local network segment; and
wherein at least one of the mobile terminal and network entity are configured to,
send an announcement describing available services, wherein the announcement is receivable by any device on the local network segment;
receive a request for detailed description of the service information in response to the announcement;
send a description of the service to the originator of the request in response to the request; and
wherein the mobile terminal and network entity are capable of establishing the service between the mobile terminal and the network entity in response to the sending of the description of the service.

26. The system of claim 25, wherein the network entity comprises a network proxy capable of registering the communications device for purposes of making the communications device accessible via the mobile data network.

27. The system of claim 26, wherein establishing the service between the communications device and the network proxy involves exchanging Session Initiation Protocol messages between the communications device and the network proxy.

28. The system of claim 25, wherein at least one of the mobile terminal and network entity are further configured to register the communications device in a globally accessible registrar.

29. The system of claim 25, wherein the service comprises a presence service that indicates conditions under which a user of the communications device may be contacted.

30. The system of claim 25, wherein sending the announcement describing the available services comprises sending the announcement using a Simple Service Discovery Protocol message.

31. The system of claim 25, wherein the sending of the announcement, the receiving of the request, and the sending of the description of the service are performed in conformance with Universal Plug and Play discovery protocols.

32. The system of claim 31, wherein the establishing the service between the communications device and the network entity comprises establishing a media session using the Session Initiation Protocol.
